(19) United States
(12) Patent Application Publication
(10) Pub. No.: US 2007/0065623 A1
(43) Pub. Date: Mar. 22, 2007

(54) Laser-imageable coating based on exothermic decomposition

(76) Inventors: Vladek Kasperchik, Corvallis, OR (US); Makarand P. Gore, Corvallis, OR (US); Mehrgan Khavarj, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/232,066

(22) Filed: Sep. 21, 2005

(51) Int. Cl. B32B 3/02

(52) U.S. Cl. 428/64.4

(57) ABSTRACT

An optical recording medium comprises a substrate, an imaging layer comprising a compound that decomposes exothermically when heated to a predetermined temperature, and, optionally, a color layer.

### BACKGROUND

Digital data are recorded on CDs, DVDs, and other optical media by using a laser to create pits in the surface of the medium. The data can then be read by a laser moving across the surface and detecting variations in the reflectivity of the surface. While this method is highly effective for creating machine-readable features on the optical medium, those features are not easily legible to the human eye.

Materials that change visibly upon stimulation with energy such as light or heat may be used to create human-readable images. For ease of discussion, and without subscribing to any particular effect, such materials will be referred to herein as “thermochromic materials” (which change color by the action of heat) and that term as used herein is intended to encompass materials that change color as a result of heat generated by the absorption of light.

It is particularly desirable to provide a coating that can be stimulated to change using the same laser that is used to burn digital data onto the optical media. With such a coating, a single system could be used to produce both machine- and human-readable data on a CD, DVD, or other optical device.

In addition, many previous coatings rely on spontaneous mixing of two or more components in order to produce a visible mark. Mixing of the components does not occur until the coating is locally heated to its melting point. Thus, the time heat and then mix the ink components each limit the speed with which a mark can be generated. Another problem with prior coatings is that they may be susceptible to extraneous marking or deterioration of image quality if the marking system is too sensitive or not robust enough. Still further, some marking systems make use of reversible chemical reactions, which makes the images even more vulnerable to degradation.

Hence, it is desirable to provide a durable coating that upon which visible markings can be made using a data-recording laser. A preferred coating would also be inexpensive and easy to apply. It is also desirable to provide a coating that is resistant to extraneous marking and yet one on which marks can be generated with relatively low energy input. Finally, it is desirable to provide a coating on which marks are less vulnerable to deterioration.

### BRIEF SUMMARY

An optical recording medium comprises a substrate and an imaging layer disposed on the substrate. When heated to a threshold temperature with a laser, the laser-decomposable material decomposes exothermically.

### BRIEF DESCRIPTION OF THE DRAWINGS

For a detailed description of exemplary embodiments of the invention, reference will now be made to the accompanying drawings, in which:

FIG. 1 is a schematic diagram illustrating an imaging medium according to an embodiment of the present invention;

FIG. 2 is a schematic diagram of the imaging medium of FIG. 1 after heat has been applied so as to leave a visible mark; and

FIG. 3 is a schematic diagram of an alternative embodiment of the imaging medium in which no topcoat and no color layer are included.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .”

The term “antenna” means a radiation-absorbing compound. The antenna readily absorbs a desired specific wavelength of the marking radiation, and transfers energy to cause or facilitate marking. As mentioned above, the term “thermochromic” includes materials that change color when heated by the absorption of light and is used herein to describe a chemical, material, or device that exhibits a color change, as discerned by the human eye, when it undergoes a change in temperature.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Referring now to the Figures, there is shown an imageable medium 100 and incident energy beam 110. Imageable medium 100 may comprise a substrate 120 having a surface 122 and an imaging layer 130 supported thereon. In the embodiment shown, imageable medium 100 also includes a topcoat 140 applied on imaging layer 130 and a color layer 150 between layer 130 and the surface 122 of substrate 120. Topcoat 140 and color layer 150 are each optional.

Substrate 120 may be any substrate upon which it is desirable to make a mark, such as, by way of example only, paper (e.g., labels, tickets, receipts, or stationary), metal, glass, ceramic, overhead transparencies, or the labeling surface of a medium such as a CD-R/RW/ROM or DVD±R/RW/ROM, HD-DVD-R recordable Blue-Ray disks and so on. Imaging composition 130 may be applied to the substrate via any suitable method(s), such as, by way of example only, rolling, spin-coating, spraying, or screen printing. The resulting layer, when dried, is preferably between 0.1 and 20 μm thick and more preferably 0.5 to 10 μm thick.

Imaging layer 130 comprises an opaque or substantially opaque colored substance that will degrade exothermally when heated to a threshold temperature. Because imaging layer 130 is colored or opaque, it prevents light from reaching the underlying substrate or color layer 150 (if one is present). Thus, marks can be made on the coated surface in by removing or altering the imaging composition 130 layer, as described below.

Examples of suitable exothermally degradable substances include but are not limited to organic nitrogen compounds such as nitrocellulose (N content 5 to 14%, more preferably 10 to 13.7%, and most preferably 12 to 13.5%), nitrostarch, nitrated sugars, polyvinyl nitrate, polynitropolyphenylene, glycidyl azide polymers, azides, peroxides, and ammonium nitrates, and the like. Potassium, sodium and tertan-butylammonium may also be suitable. The decomposition temperatures of these substances vary depending on the selection of the exothermic degradable substance. In some instances it may be desirable to select a substance that decomposes at a temperature that is readily attainable with the available equipment.

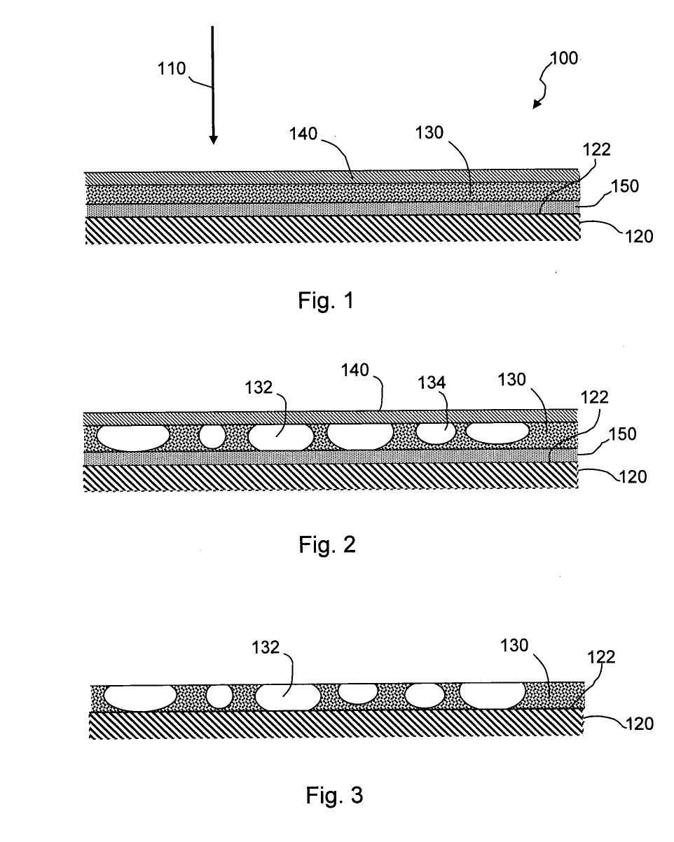

When an energy source, such as a laser of predetermined wavelength, is applied to a localized portion of imaging layer 130, localized heating of layer 130 occurs. When the decomposition temperature of layer 130 is reached, layer 130 decomposes. The exothermically degradable substances for the imaging layer are chosen such that their decomposition products are predominantly gases and water or highly volatile liquids with rather small amounts of solids produced during the decomposition. Because the heating is limited to a relatively small area upon which the laser is incident, the surrounding portions of layer 130 remain solid. The substrate acts as a heat sink and prevents spread of thermal decomposition outside of the heated area. If imageable medium 100 includes a topcoat 140, as shown in FIGS. 1 and 2, the produced gases will be trapped in voids 132 under topcoat 140. If no topcoat is present, as shown in FIG. 3, the gases will be released, leaving pits or voids 132 in imaging layer 130. In instances where it is desirable to avoid contamination of nearby equipment, such as lasers, with deposits of material from the produced gases, it is preferred to include topcoat 140.

Because the decomposition is exothermic, a relatively small amount of incident energy from the imaging laser causes the release of additional energy from the decomposition. As the result, a laser of relatively low power may trigger decomposition/ablation of significantly larger amount of the coating material than would be the case with an endothermic decomposition. In preferred embodiments, the exothermally degradable substance is selected and applied such that the amount of energy released by the imaging process is not sufficient to trigger a run-away reaction. In addition, the substrate serves as a heat sink and provides a thermal mass that helps prevent self-sustaining decomposition.

The preferred exothermally degradable substances are soluble in commercially available solvents and can be applied using screen-printing, spin-coating, knife casting or other appropriate coating technique. If desired the solution in which the exothermally degradable substance is dissolved prior to application may include a polymeric or other binder (not shown). The binder, if present, may cure or polymerize as the coating dries, improving the strength of the resulting imaging layer and improving its adhesion to the underlying surface. The binder, if present, is preferably but not necessarily substantially transparent in the amount and thickness that is used. The selection of such a binder is within the ordinary level of skill in the art.

Imaging layer 130 may further include a colorant (not shown). The colorant may be any dye or pigment that can be uniformly dissolved/dispersed in the exothermic material. In preferred embodiments, a visible colorant is used so as to provide imaging layer 130 with an appearance and/or hue that is significantly different from that of the underlying substrate (or color layer).

Topcoat 140 may be any transparent or substantially transparent polymer coating and may be solvent-based and/or radiation curable, as is known in the art. Conventional lacquers such as are currently used for CDs are examples of suitable topcoat material. Transparent overcoat should not absorb significantly radiation of the imaging laser. If provided, topcoat 140 serves to protect the surface of the optical medium and to trap and retain decomposition products of the imaging coating, whether gaseous or otherwise.

Topcoat 140 can be applied to the top surface of the imaging layer through screen-printing, spin-coating, knife casting or other appropriate coating technique.

Topcoat 140 may also contain colorant species (dyes or pigments) uniformly dissolved or dispersed in the coating material.

If present, optional color layer 150 may comprise any material that is visually different from the imaging layer, can be applied to the desired substrate as a coating layer, and can form a supporting surface to which the imaging layer can adhere. It is preferred that color layer 150 comprise a material that is visually different from the imaging layer so there will be a visual contrast with imaging layer in spots where the imaging layer is removed. Color layer 150 may be any color, but is preferably a color that contrasts with the color or appearance of imaging layer 130. Hence, coating layer may be a layer of black or dark-colored paint, such as those based on carbon black or a leuco dye and acid combination Examples of suitable undercoats include but are not limited to radiation-curable or solvent-based lacquer with light-colored (white) pigment dispersed (for use with dark-colored imageable layers) or lacquer layer with dark (black) pigment or dye dispersed therein (for use with opaque, light-colored (white) imageable layers). In some embodiments, it may be desired to provide a color layer 150 having non-uniform coloring across the surface of the substrate.

One or more of imaging layer 130, color layer 150 (if present), and/or the surface 122 of substrate 120 may include an absorber or antenna so as to increase absorbance of the available light energy. A preferred antenna comprises a dye or combination of dyes having an absorbance peak wavelength tuned to that of the imaging laser. By effectively absorbing the available light, the absorber or antenna increases efficiency of the heating effect of the laser, thereby enhancing the imaging ability (we are not talking about thermochromic systems here).

If present, the antenna may comprise any of a number of compositions that preferentially absorb light at a wavelength. The content of the antenna in the imaging composition may be in the range of 0.05 to 50%, is preferably in the range of 0.1 to 10%, and more preferably in the range of 0.1 to 5%. In order to ensure that the imaging layer performs consistently and uniformly, it is preferred that the antenna be uniformly dissolved or dispersed in the imaging layer(s) or other layer(s).

Examples of suitable antenna dyes for imaging lasers of different wavelength include but are not limited to, for a 780 nm (CD burner laser): Indocyanine IR-dyes such as IR780 (Aldrich 42,531-1) (1) (3H-Indolium, 2-[2-[2-chloro-3-[(1,3-dihydro-3,3-dimethyl-1-propyl-2H-indol-2-ylidene)ethylidene]-1-cyclohexen-1-yl]ethenyl]-3,3-dimethyl-1-propyl-, iodide (9Cl)), IR783 (Aldrich 54,329-2) (2) (2-[2-[2-Chloro-3-[2-[1,3-dihydro-3,3-dimethyl-1-(4-sulfobutyl)-2H-indol-2-ylidene]-ethylidene]-1-cyclohexen-1-yl]-ethenyl]-3,3-dimethyl-1-(4-sulfobutyl)-3H-indolium hydroxide, inner salt). Also useful are Phthalocyanine or naphthalocyanine IR dyes.

For a 650 nm (DVD burner laser), suitable dyes include but are not limited to: dye 724 (3H-Indolium, 2-[5-(1,3-dihydro-3,3-dimethyl-1-propyl-2H-indol-2-ylidene)-1,3-pentadienyl]-3,3-dimethyl-1-propyl-, iodide) ^{••}C (lambda max=642 nm), dye 683 (3H-Indolium, 1-butyl-2-[5-(1-butyl-1,3-dihydro-3,3-dimethyl-2H-indol-2-ylidene)-1,3-pentadienyl]-3,3-dimethyl-, perchlorate ^{••}C (lambda max=642 nm), and dyes derived from phenoxazine such as Oxazine 1 (Phenoxazin-5-ium, 3,7-bis(diethylamino)-, perchlorate) ^{••}C (lambda max=645 nm). These and other suitable dyes are available from “Organica Feinchemie GmbH Wollen”
(A) silicon 2,3 naphthalocyanine bis(trihexylsilyloxide) (Formula 1) (Aldrich 38,993-5, available from Aldrich, P.O. Box 2060, Milwaukee, Wis. 53201), and matrix soluble derivatives of 2,3 naphthalocyanine (Formula 2) 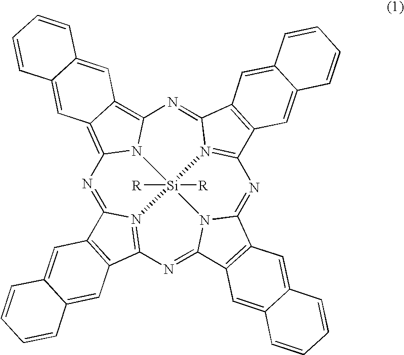
where R=—O—Si—(CH₂(CH₂)₄CH₃)₃; 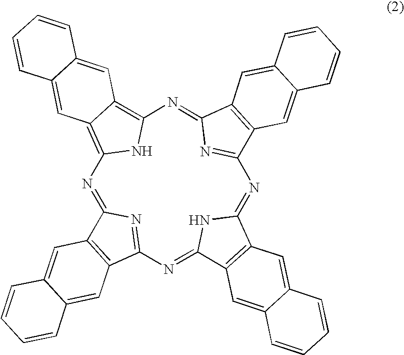
(B) matrix soluble derivatives of silicon phthalocyanine, described in Rodgers, A. J. et al., 107 J. PHYS. CHEM. A 3503-3514 (May 8, 2003), and matrix soluble derivatives of benzophthalocyanines, described in Aoudia, Mohamed, 119 J. AM. CHEM. SOC. 6029-6039 (Jul. 2, 1997), (substructures illustrated by Formula 3 and Formula 4, respectively): 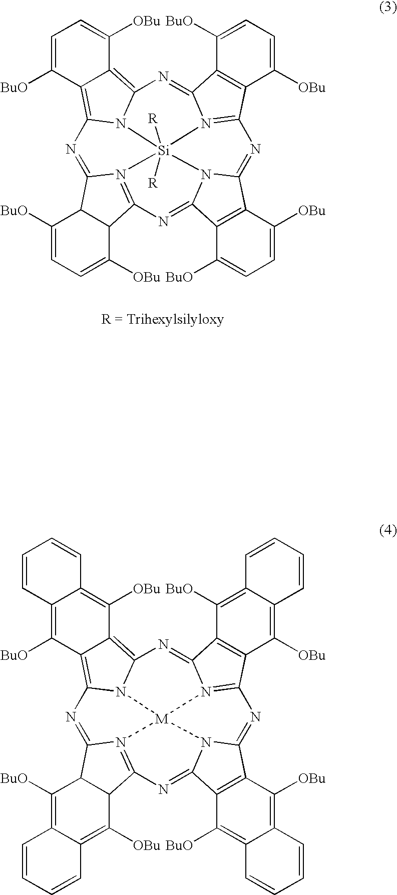
where M is a metal, and;
(C) compounds such as those shown in Formula 5 (as disclosed in U.S. Pat. No. 6,015,896) 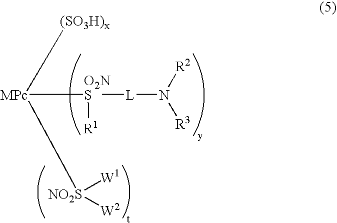
where M is a metal or hydrogen; Pc is a phthalocyanine nucleus; R¹, R², W¹, and W² are independently H or optionally substituted alkyl, aryl, or aralkyl; R³ is an aminoalkyl group; L is a divalent organic linking group; x, y, and t are each independently 0.5 to 2.5; and (x+y+t) is from 3 to 4;
(D) compounds such as those shown in Formula 6 (as disclosed in U.S. Pat. No. 6,025,486) 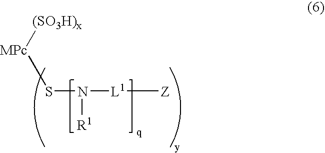
where M is a metal or hydrogen; Pc is a phthalocyanine nucleus; each R¹ independently is H or an optionally substituted alkyl, aryl, or aralkyl; L¹ independently is a divalent organic linking group; Z is an optionally substituted piperazinyl group; q is 1 or 2; x and y each independently have a value of 0.5 to 3.5; and (x+y) is from 2 to 5; or
(E) 800NP (a proprietary dye available from Avecia, PO Box 42, Hexagon House, Blackley, Manchester M9 8ZS, England), a commercially available copper phthalocyanine derivative.

When it is desired to create a visible mark on imageable medium 100, energy 110 may be directed imagewise onto the surface of imageable medium 100. The form of energy 110 may vary depending upon the equipment available, ambient conditions, and desired result. Examples of energy that may be used include but are not limited to IR radiation, UV radiation, x-rays, or visible light. The antenna absorbs the incident energy and causes localized heating of the imaging layer 130. The localized heat causes layer 130 decompose, producing voids 132 filled with gaseous reaction products. In doing so: either a) the substrate (or color layer) becomes visible through voids in colored or opaque imageable layer or b) light scattering by voids in the continuous imageable layer makes a visible image. The latter effect produces a visible image even with clear/colorless imageable layers. Transparent exothermic material layer on top of dark undercoat can be imaged successfully with laser. Voids created in the transparent imageable layer may scatter enough light to make the image clearly visible. Optional clear overcoat will further enhance the image visibility.

The temperature required to cause melting and collapse of the layer 130 vary, depending on the material that is used. In some embodiments, the temperature required is between about 80° C. and 450° C., more preferably between about 120° C. and 400° C., and in some instances may be between about 150° C. and 250° C. This is significantly lower than many previously known laser-imageable coatings. Because the target area is relatively small, the coating is relatively thin, and the coating is in contact with the significantly thicker substrate, the areas adjacent to the imaged area cool relatively quickly and do not decompose or interfere with subsequent processing of the medium.

The voids 132 remaining after localized decomposition are at least translucent and may be transparent. Thus, the visual contrast of the resulting marks can be defined by the visual contrast between imaging layer 130 and substrate. In some embodiments, voids 132 may extend through the thickness of imaging layer 130 such that the surface 122 of the substrate or color layer 150 (if present) is visible through the voids. In other embodiments, the material of which layer 130 is formed and the manner in which the laser energy is applied may be selected such that partial voids 134 (FIG. 2) that do not extend through the thickness of layer 130 are formed. These partial voids 134 may be light scattering and therefore visible marks may be made regardless of the level of visible contrast between imaging layer 130 and surface 122 or color layer 150.

It is expected that the amount of heat required to mark the pigment will be significantly less than the amount of heat required to mark previously known coatings. This is due in part to the fact that the energy available for marking is not limited to the absorbed laser energy but also includes the energy released from decomposition of the exothermic material. In turn, the reduced heat requirement reduces the marking speed, increasing productivity.

Another advantage of the present coating is that the decomposition reaction is irreversible. Hence, marks formed in layer 130 will not fade or disappear with time. In this respect, the present imaging coatings are superior to those based on leuco-dye thermochromic chemistry.

Both the laser-imageable layer and the optional transparent overcoat can be easily formulated as single-phase solvent-based coating solutions. They can be easily applied to the substrate surface either through spin-coating or screen-printing.

### EXAMPLES

By way of example only, a composition that can be spin-coated onto the substrate to form an imageable layer in accordance with preferred embodiments comprises:

Imaging Layer Formulation For Spin-Coating

| | |
|---|---|
| Ingredient | Weight % |

| | | |
|---|---|---|
| 1 | 2-ethoxy ethanol | 22.50% |
| 2 | MEK | 22.50% |
| 3 | 4-methyl 2-pentanone | 24.40% |
| 4 | IR780-35% | 1.00% |
| 5 | nitrocellulose impreganted with IPA (70%) | 27.50% |
| 6 | BYK UV-3510 | 0.60% |
| 7 | Savinyl Blue RS Dye | 1.50% |
| 8 | Total | 100.00% |

By way of example only, a composition that can be screen-printed onto the substrate to form an imageable layer in accordance with preferred embodiments comprises:

Imaging Layer Formulation For Screen-Printing

| Ingredient | | Weight % |
|---|---|---|
| 1 | 2-ethoxy ethanol | 12.80% |
| 2 | MEK | 12.80% |
| 3 | 4-methyl 2-pentanone | 12.80% |
| 4 | IR780-35% | 1.00% |
| 5 | nitrocellulose impreganted with IPA (70%) | 58.50% |
| 6 | BYK UV-3510 | 0.60% |
| 7 | Savinyl Blue RS Dye | 1.50% |
| 8 | Total | 100.00% |

In each Example above, ingredients 1-3 serve as solvents, ingredient 4 serves as an antenna dye, ingredient 5 is the exothermic material, ingredient 6 is a surfactant, and ingredient 7 is a visible colorant. The selection and relative amount of each ingredient will depend on many factors, which will be known and understood by those skilled in the art.

The imaging compositions formed in the manner described herein can be applied to the surface of an optical recording medium such as a CD, DVD, or the like. When the color-forming agent, optional antenna, and other components are selected appropriately, the same laser that is used to “write” the machine-readable data onto the optical recording medium can also be used to “write” human-readable images, including text and non-text images, onto the medium.

In certain embodiments, the machine-readable layers are applied to one surface of the optical recording medium and the present imaging compositions are applied to the opposite surface of the optical recording medium. In these embodiments, the user can remove the disc or medium from the write drive after the first writing process, turn it over, and re-insert it in the write drive for the second writing process, or the write drive can be provided with two write heads, which address opposite sides of the medium. Alternatively, separate portions of one side of the optical recording medium can be designated for each of the machine- and human-readable images.

Thus, embodiments of the present invention are applicable in systems comprising a processor, a laser coupled to the processor, and a data storage medium including a substrate having a first surface that can be marked with machine-readable marks by said laser and a second surface that can be marked with human-readable marks by said laser. The second surface includes an imaging composition in accordance with the invention, comprising an optional color layer, and a layer of light-scattering meltable pigment.

The present invention allows a higher writing speed, excellent image quality and image permanence, and ease of formulation and application.

The above discussion is meant to be illustrative of the principles and various embodiments of the present invention. Numerous variations and modifications will become apparent to those skilled in the art once the above disclosure is fully appreciated. For example, the composition and relative amount of the matrix, color-forming agent, nucleating agent, developer, if any, and photoabsorber, if any, can all be varied. It is intended that the following claims be interpreted to embrace all such variations and modifications. Similarly, unless explicitly so stated, the sequential recitation of steps in any claim is not intended to require that the steps be performed sequentially or that any step be completed before commencement of another step.

What is claimed is:

1. An optical recording medium, comprising:
a substrate,
an imaging layer supported on said substrate and comprising a compound that decomposes exothermically when heated to a predetermined temperature; and
optionally, a color layer between said substrate and said imaging layer.

2. The optical recording medium of claim 1 wherein the imaging layer comprises an organic nitrogen compound.

3. The optical recording medium of claim 1 wherein the imaging layer comprises a compound selected from the group consisting of nitrocellulose, nitrostarch, nitrated sugars, polyvinyl nitrate, polynitropolyphenylene, glycidyl azide polymer, azides, peroxides, potassium, sodium and tertan-butylammonium, ammonium nitrates, and combinations thereof.

4. The optical recording medium of claim 1 wherein the imaging layer further includes a colorant.

5. The optical recording medium of claim 1 wherein said imaging layer further includes a binder.

6. The optical recording medium of claim 1 wherein said imaging layer further includes a light-absorbing antenna.

7. The optical recording medium of claim 1, further including a topcoat on said imaging layer.

8. A means for providing human-readable and machine-readable marks on an optical recording medium, comprising:
first means for recording machine-readable marks on said medium in response to an optical signal;
second means for recording human-readable marks on said medium, said second means including an imaging layer that produces a human-detectable optical change when heated to a threshold temperature, wherein said imaging layer comprises an imaging compound that decomposes exothermically when heated to said threshold temperature.

9. The recording means of claim 8 wherein the imaging layer comprises an organic nitrogen compound.

10. The recording means of claim 8 wherein the imaging layer comprises a compound selected from the group consisting of nitrocellulose, nitrostarch, nitrated sugars, polyvinyl nitrate, polynitropolyphenylene, glycidyl azide polymer, and combinations thereof.

11. The recording means of claim 8 wherein the imaging layer further includes a colorant.

12. The recording means of claim 8 wherein said imaging layer further includes a binder.

13. The recording means of claim 8 wherein said imaging layer further includes a light-absorbing antenna.

14. The recording means of claim 8, further including a topcoat on said imaging layer.

15. A system, comprising:
a processor,
a laser coupled to said processor;
a data storage medium including a substrate having a first surface that can be marked with machine-readable marks by said laser and a second surface that can be marked with human-readable marks by said laser, said second surface including an imaging layer thereon, said imaging composition comprising:
an imaging compound that decomposes exothermically when heated to said threshold temperature; and
optionally, a color layer between said second surface and said imaging layer.

16. The system of claim 15 wherein the imaging layer comprises an organic nitrogen compound.

17. The system of claim 15 wherein the imaging layer comprises a compound selected from the group consisting of nitrocellulose, nitrostarch, nitrated sugars, polyvinyl nitrate, polynitropolyphenylene, glycidyl azide polymer, and combinations thereof.

18. The system of claim 15 wherein the imaging layer further includes a colorant.

19. The system of claim 15 wherein said imaging layer further includes a binder.

20. The system of claim 15 wherein said imaging layer further includes a light-absorbing antenna.

21. The system of claim 15, further including a topcoat on said imaging layer.

22. A method for creating an optical recording medium on a substrate, comprising:
a) providing a first coating on a first part of the substrate surface, said first coating forming machine-readable marks in response to incident light having a predetermined wavelength; and
b) providing a second coating on a second part of the substrate surface, said second coating forming human-readable marks in when heated to a threshold temperature by:
providing material that decomposes exothermically at said threshold temperature in a solvent to form a coating;
applying the coating to the surface of the substrate;
allowing the solvent to evaporate.

23. The method of claim 22 wherein the imaging layer comprises an organic nitrogen compound.

24. The method of claim 22 wherein the imaging layer comprises a compound selected from the group consisting of nitrocellulose, nitrostarch, nitrated sugars, polyvinyl nitrate, polynitropolyphenylene, glycidyl azide polymer, and combinations thereof.

25. The method of claim 22 wherein the imaging layer further includes a colorant.

26. The method of claim 22 wherein said imaging layer further includes a binder.

27. The method of claim 22 wherein said imaging layer further includes a light-absorbing antenna.

28. The method of claim 22, further the step of
c) applying a topcoat to said second layer.
